(19) United States
(12) Patent Application Publication
(10) Pub. No.: US 2023/0375028 A1
(43) Pub. Date: Nov. 23, 2023

(54) TILE TOOL NUT

(71) Applicant: Calidad Tools, LLC, Las Vegas, NV (US)

(72) Inventor: Andrew Eylander, Carlsbad, CA (US)

(21) Appl. No.: 18/198,413

(22) Filed: May 17, 2023

Related U.S. Application Data
(60) Provisional application No. 63/343,031, filed on May 17, 2022.

(51) Int. Cl. F16B 23/00

(52) U.S. Cl. CPC F16B 23/00; B24B 45/00

(57) ABSTRACT

A system, method, and apparatus for a non-marking impact resistant nut includes a cone shaped nut body, a central tubular channel formed in the cone shaped body, female threading formed in the central tubular channel, and at least two mounting holes formed in the cone shaped body.

### CROSS REFERENCE TO RELATED PATENT APPLICATIONS

This patent application claims the priority and benefit under 35 U.S.C. § 119(e) of U.S. Provisional Patent Application Ser. No. 63/343,031 filed May 17, 2022, entitled “TILE TOOL.” U.S. Provisional Patent Application Ser. No. 63/343,031 is herein incorporated by reference in its entirety.

### TECHNICAL FIELD

Embodiments are generally related to the field of construction. Embodiments are also related to the field of tools. Embodiments are further related to the field of tools for construction. Embodiments are further related to tools for saws or other cutting devices. Embodiments are further related to tools for cutting tile.

### BACKGROUND

Many construction projects require cuts, at various angles, with common cutting tools. For most tile applications the blade is a circular grinding wheel that spins in order to cut or grind the tile. Most grinder blades are bound to the saw with a nut. The nut is commonly made of metal and designed for metal fabrication applications. Nevertheless, the availability of this solution means that many people use the same tool with the same nut to cut tile and other non-metal materials.

The normal nut that is used to connect the grinder blade to saw tends to leave a streak or mark on the tile, or other surfaces, when the nut contacts the tile as a cut is made. In addition, in certain cases the nut will chip the tile when the nut contacts the tile. This is particularly common when angled or beveled cuts are necessary. One such prior art nut 105 and the associated marking 110 on the tile, is illustrated in FIG. 1, labeled as “prior art.”

The markings on tile from prior art nuts are generally irremovable. In addition, if a tile is chipped it must be recut and the tile must be replaced. In aggregate, this can significantly reduce efficiency and increase the cost of tile installation.

As such, there is a need in the art for systems, methods, and tools for reducing tile marking and cuts from tile grinders or saws, as disclosed herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a tool.

It is another aspect of the disclosed embodiments to provide a tile saw tool.

It is another aspect of the disclosed embodiments to provide a tile grinder tool.

It is another aspect of the disclosed embodiments to provide a method and system or apparatus for connecting grinder blades or saw blades to power tools.

It is another aspect of the disclosed embodiments to provide a nut for connecting a cutting tool to a saw or other tool configured to spin the cutting instrument.

It is another aspect of the disclosed embodiments to provide a method and system or apparatus for providing a no-nip no-mark nut (or flange) for connecting a tile grinder to a tile cutting tool.

The aforementioned aspects and other objectives and advantages can now be achieved as described herein. For example, in an embodiment, a non-marking impact resistant nut comprises a substantially cone shaped body, a central tubular channel formed in the cone shaped body, female threading formed in the central tubular channel, and at least two mounting holes formed in the cone shaped body. In an embodiment, the body comprises a single seamless piece. In an embodiment, the cone shaped body is milled. In an embodiment, the body further comprises acetol. In an embodiment the non-marking impact resistant nut further comprises an excised outer portion of the cone shaped body and a substantially flat inner surface. In an embodiment the non-marking impact resistant nut further comprises a substantially flat base. In an embodiment the non-marking impact resistant nut further comprises a chamfer in the flat base around the opening of the central tubular channel. In an embodiment the at least two mounting holes are configured linearly with the central tubular channel. In an embodiment, the non-marking impact resistant is configured to fit flush against a grinder associated with a cutting tool. In an embodiment, the non-marking impact resistant nut is configured to fit flush against a blade associated with a cutting tool.

In another embodiment, a flange comprises a body tapered from a base of the body to the top of the body, a central tubular channel formed in the body, female threading formed in the central tubular channel, and at least two mounting holes formed in the cone shaped body. In an embodiment, the base of the body comprises a substantially flat base. In an embodiment the flange further comprises a chamfer in the flat base around the opening of the central tubular channel. In an embodiment the flange further comprises a lip formed at an opening of the central tubular channel proximate to the base. In an embodiment the body further comprises acetol. In an embodiment, the flange is configured to fit flush against a grinder associated with a cutting tool. In an embodiment the flange body comprises a single seamless piece. In an embodiment the at least two mounting holes are configured linearly with the central tubular channel. In an embodiment, a diameter of the base of the body is larger than a diameter of the top of the body.

In another embodiment, a non-marking impact resistant nut comprises a substantially cone shaped body comprising a single seamless piece, wherein a diameter of a base of the body is larger than a diameter of a top of the body, a central tubular channel formed in the cone shaped body, female threading formed in the central tubular channel, at least two mounting holes formed in the cone shaped body, wherein the non-marking impact resistant nut is configured to fit flush against a grinder associated with a cutting tool.

### BRIEF DESCRIPTION OF THE FIGURES

The accompanying figures, in which like reference numerals refer to identical or functionally similar elements throughout the separate views and which are incorporated in, and form a part of the specification, further illustrate the embodiments and, together with the detailed description, serve to explain the embodiments disclosed herein.

FIG. 1 depicts a prior art saw nut;

FIG. 2A depicts a top perspective view of a non-marking impact resistant nut, in accordance with the disclosed embodiments;

FIG. 2B depicts a top view of a non-marking impact resistant nut, in accordance with the disclosed embodiments;

FIG. 2C depicts an elevation view of a non-marking impact resistant nut, in accordance with the disclosed embodiments;

FIG. 2D depicts a bottom perspective view of a non-marking impact resistant nut, in accordance with the disclosed embodiments;

FIG. 2E depicts a bottom view of a non-marking impact resistant nut, in accordance with the disclosed embodiments;

FIG. 3 depicts a non-marking impact resistant nut engaged to a tile grinder, in accordance with the disclosed embodiments;

FIG. 4A depicts bottom view of another embodiment of a non-marking impact resistant nut, in accordance with the disclosed embodiments;

FIG. 4B depicts a side view of another embodiment of a non-marking impact resistant nut, in accordance with the disclosed embodiments;

FIG. 4B depicts another rear view a square tool, in accordance with the disclosed embodiments; and

FIG. 5 depicts steps associated with a method for cutting tile, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. All aspects of the various embodiments can be interchangeable with aspects disclosed in other embodiments, and/or can be incorporated in other embodiments.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope and concept of the invention as defined by the appended claims.

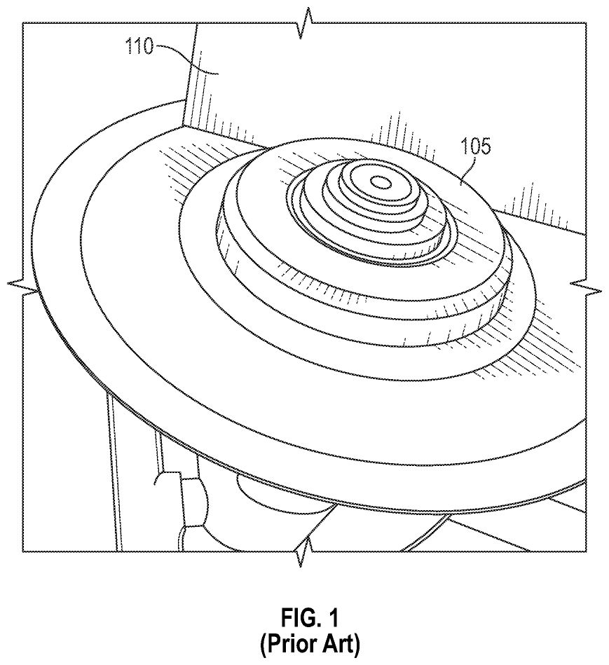

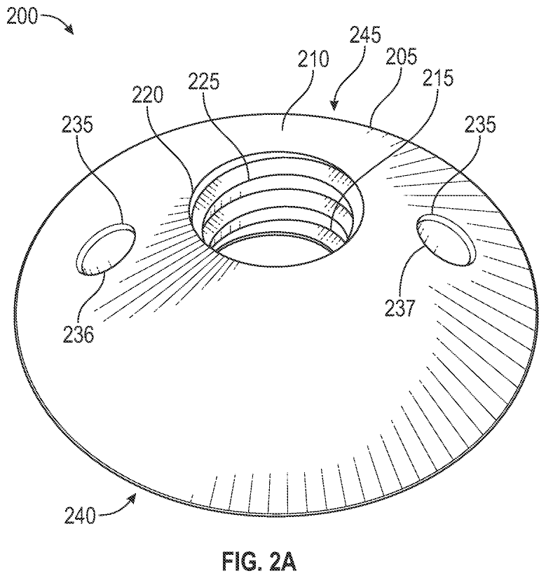

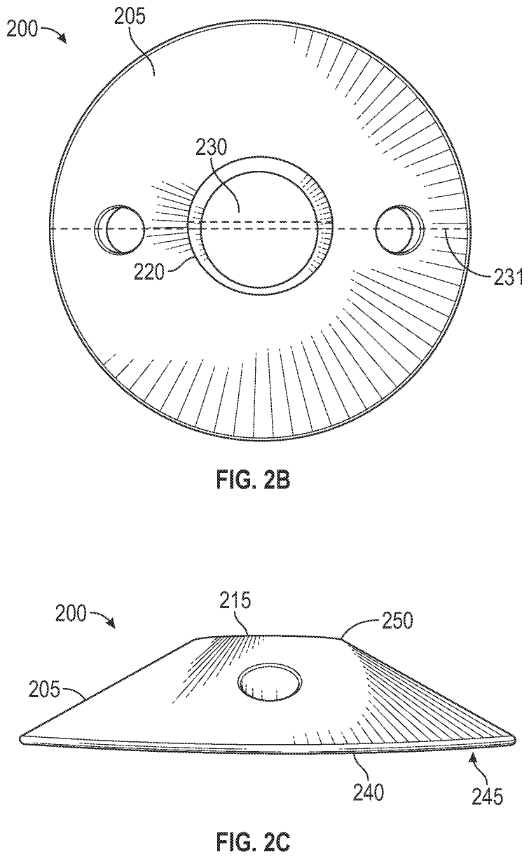

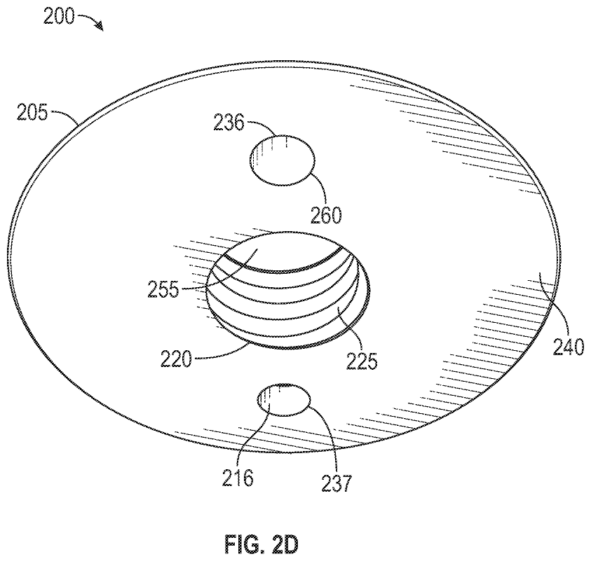

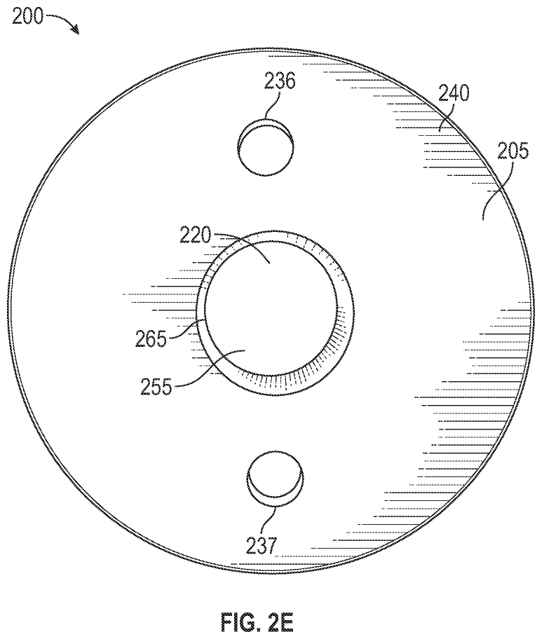

In certain embodiments, a non-marking impact resistant nut, or locking flange, is illustrated in FIGS. 2-4. The non-marking impact resistant nut allows the user to avoid damage to tile during the cutting process with a grinder, saw, or other such tool. The non-marking impact resistant nut will not chip the work piece (e.g., tile) during a miter cut, nor will it mark/mar the tile, as compared to a standard metal nut, as illustrated in FIG. 1, which leaves a burn 110 in the tile surface that often cannot be removed.

The non-marking impact resistant nut (or locking flange) generally comprises a cone shaped body, designed to glance off the edge or surface of the tiles without chipping or marring them. This non-marking impact resistant nut can be made of a non-marking, machinable plastic or other such material. In certain embodiments, the preferred material is acetol which is sufficiently soft to avoid chipping but also sufficiently strong to securely affix the grinder blade or saw blade to the saw. In other embodiments, other materials can be used, provided such materials do not leave marks on the tile.

In certain embodiments, the non-marking impact resistant nut can be configured as a single piece. In certain embodiments, this can be achieved by making the non-marking impact resistant nut by milling so that there are no seams along the nut body that would compromise the integrity of the non-marking impact resistant nut during use. The nut body is design to withstand the high speeds of a grinder running at up to 20,000 RPMs without a weak point created by a seam or other such joint created in the manufacturing process.

FIG. 2A depicts a top perspective view of a non-marking impact resistant nut or flange 200, in accordance with the disclosed embodiments. As illustrated in FIG. 2A, the non-marking impact resistant nut 200 can comprise a nut body 205 with a generally coned shape 210 tapering from the center 215, of the nut body 205, to a larger diameter outer perimeter 245.

The center 215 of the coned shaped body 205 can include a tubular channel 220 with female threading 225. The diameter 230 of the tubular channel 220 and dimensions of the threading 225 can be selected to match one of various grinder models. It should be appreciated that most grinders or tile saws have a standard size spindle. The dimensions of the tubular channel 220 and threading 225 can be selected to match standard spindle dimensions.

The cone shaped body 205 can further include a pair of mounting holes 235, first mounting hole 236 and second mounting hole 237, formed across from one another on either side of the central tubular channel 220. The mounting holes 235 can be circular tubes formed in the nut body 205, and are configured to aid in the application of torque to secure the non-marking impact resistant nut 200 to the spindle of a grinder, or other such cutting tool. The bottom or base 240 of the non-marking impact resistant nut 200 can be configured to be substantially flat and circular so that it can properly secure against the grinder wheel or saw blade.

In practice, the non-marking impact resistant nut 200 (or flange) can be used in conjunction with a backing flange, also known as an inner flange. The backing flange can fit onto the spindle of the grinder behind the grinding wheel. The grinder spindle can include male threads which match the female threads 225 on the tubular channel 220 of the non-marking impact resistant nut 200. With the backing flange in place, the grinding wheel (or other circular cutting tool) can be installed over the backing flange on the spindle. The non-marking impact resistant nut 200 can then be positioned on the exterior facing side of the grinding wheel, with the flat side of the non-marking impact resistant nut 200 securely against the grinding wheel. This can be accomplished by engaging the non-marking impact resistant nut 200 threads 225 to the spindle threads, and tightening the nut 200 with the mounting holes 235.

FIG. 2B depicts a top view of a non-marking impact resistant nut 200, in accordance with the disclosed embodiments. As illustrated in FIG. 2B, the diameter 230 of the tubular channel, is smaller than the total diameter 231 of the outer perimeter 245.

FIG. 2C depicts an elevation view of a non-marking impact resistant nut 200 in accordance with the disclosed embodiments. In this view, the tapering from the center 215, of the nut body 205, to a larger diameter outer perimeter 245. As illustrated, the top 250 of the nut body 205 can be flattened. This view further illustrates that the base 240 of the nut body 205 can be flat.

FIG. 2D depicts a bottom perspective view of a non-marking impact resistant nut 200, in accordance with the disclosed embodiments. This view illustrates the arrangement of the bottom opening 255 associated with the tubular channel 220. The first mounting hole 236 further includes bottom opening 260, and the second mounting hole 237 has bottom opening 261.

FIG. 2E depicts a bottom view of a non-marking impact resistant nut 200, in accordance with the disclosed embodiments. As illustrated in FIG. 2E, the tubular channel 220 is configured in line with the first mounting hole 236 and second mounting hole 237. In certain embodiments, the bottom opening 255 can include chamfer 265.

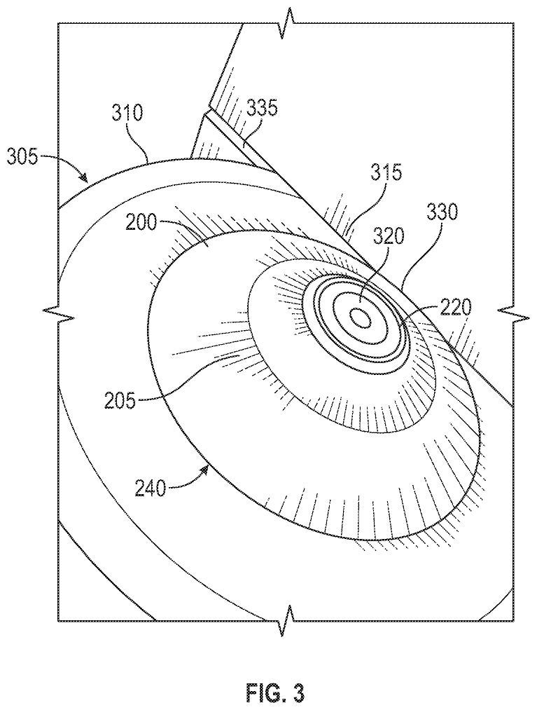

FIG. 3 depicts a non-marking impact resistant nut 200 engaged to a cutting tool 305, in accordance with the disclosed embodiments. For example, in an embodiment the non-marking impact resistant nut 200, or locking flange, can be affixed to a grinding wheel 310 associated with a cutting tool 305 such as a tile grinder. The grinding wheel 310 can be used to cut a tile or other such material, such as tile 315.

The non-marking impact resistant nut 200 is configured to engage the male threads of a spindle 320. The nut 200 is configured such that the base 240 mounts flush to the grinding wheel 305. The depth of the nut 200 can be selected such that the nut 200 is secured on the spindle 320, but also so that the spindle 320 does not extend beyond the tubular channel 220 of the nut 200. In other embodiments, it is acceptable for the spindle to extend beyond the tubular channel 220.

As illustrated in FIG. 3, the non-marking impact resistant nut 200 can contact the tile 315 at the contact point 330, as a cut 335 is made in the tile 315, without leaving any burn or mark on the tile 315. Likewise, the non-marking impact resistant nut 200 does not chip or damage the tile 315 as it is cut.

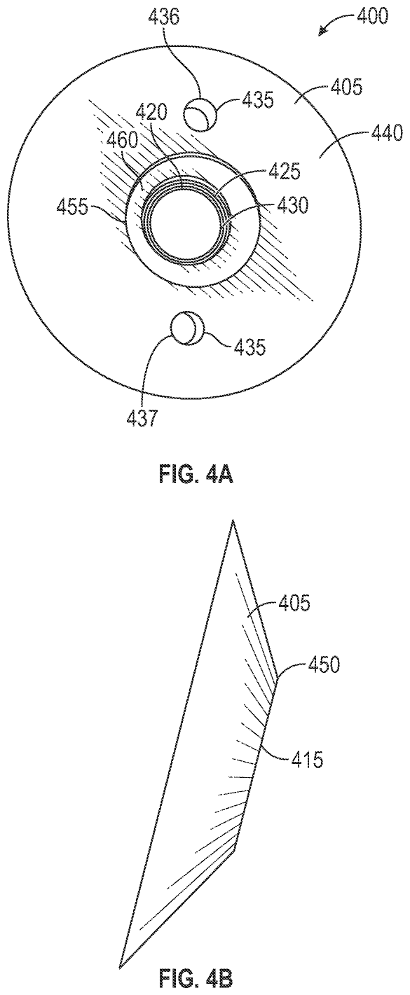

FIGS. 4A and 4B illustrate aspects of another embodiment of a non-marking impact resistant nut or flange 400, in accordance with the disclosed embodiments. The non-marking impact resistant nut 400 can include some or all of the aspects illustrated in FIGS. 2A-E and FIG. 3.

The non-marking impact resistant nut 400 can comprise a nut body 405 with a generally coned shape 410 tapering from the center 415, of the nut body 405, to a larger diameter outer perimeter 445.

The center 415 of the coned shaped body 405 can include a tubular channel 420 with female threading 425. The diameter 430 of the tubular channel 420 and dimensions of the threading 425 can be selected to match one of various grinder models. It should be appreciated that most grinders have a standard size spindle. The dimensions of the tubular channel 420 and threading 425 can be selected to match standard spindle dimensions.

The cone shaped body 405 can further include a pair of mounting holes 435, first mounting hole 436 and second mounting hole 437, formed axially from one another on either side of the central tubular channel 420. The mounting holes 435 can be circular tubes formed in the nut body 405, and are configured to aid in the application of torque to secure the non-marking impact resistant nut 400 to the spindle of a grinder, or other such cutting tool. The bottom or base 440 of the non-marking impact resistant nut 400 can be configured to be substantially flat so that it can properly secure against the grinder wheel.

In practice, the non-marking impact resistant nut 400 (or flange) can be used in conjunction with a backing flange, also known as an inner flange. The backing flange can fit onto the spindle of the grinder behind the grinding wheel. The grinder spindle can include male threads which match the female threads on the tubular channel 420 of the non-marking impact resistant nut 400. With the backing flange in place, the grinding wheel (or other circular cutting tool) can be installed over the backing flange on the spindle. The non-marking impact resistant nut 400 can then be positioned on the exterior facing side of the grinding wheel, with the flat side of the non-marking impact resistant nut 400 securely against the grinding wheel. This can be accomplished by engaging the non-marking impact resistant nut 400 threads to the spindle threads, and tightening the nut 400 with the mounting holes 435.

The cone shaped body 405 is configured such that the top 450 is flattened. A center tubular channel 420 can include female threading 425. Two mounting holes 435 can be formed across from one another, and equidistant from the tubular channel 420. As illustrated, the flat bottom surface 440 can include a lip 455 formed by recessing 460 a select diameter around the center tubular channel 420.

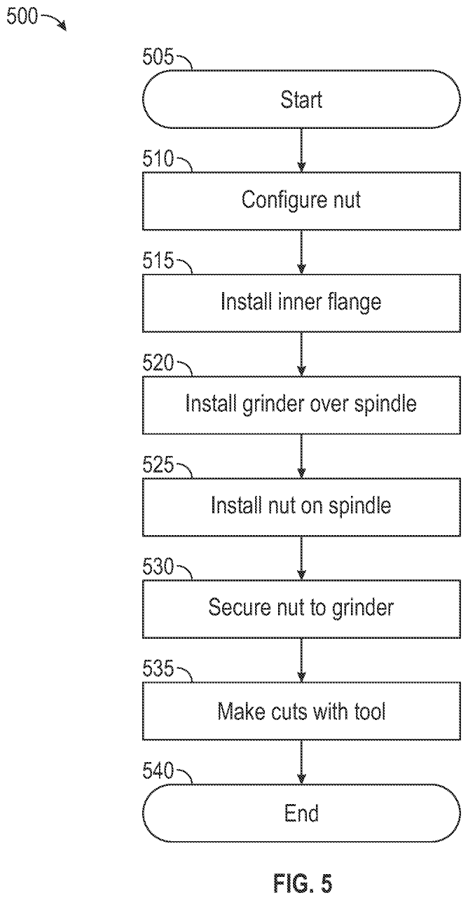

FIG. 5 illustrates a flow chart of steps associated with a method 500 for cutting tile. The method begins at step 505.

At step 510, a non-marking impact resistant nut, such as nut 200 or nut 400 can be configured. In certain embodiments, the non-marking impact resistant nut can be configured as illustrated in FIGS. 2-4. This can include forming the nut 200 or nut 400 as a single piece so that there are no seams or joints in the nut body 205 or nut body 405.

Next, an inner flange can be installed on the spindle of the cutting tool (e.g., a grinder) at step 515. With the inner flange installed, the grinder or other such cutting blade can be installed on the spindle at step 520.

At step 525, the non-marking impact resistant nut can then be secured to the grinder with the flat side facing the grinder. The non-marking impact resistant nut can be tightened against the grinder with the mounting holes and a pronged tool designed to impart torque on the non-marking impact resistant nut at step 530. The mounting holes are important for this purpose since they allow the application of sufficient torque to secure the nut to the grinder.

Once the non-marking impact resistant nut is installed on the grinder, at step 535 the tool can be used to cut tile or other such materials. When the non-marking impact resistant nut touches the material being cut, it will not chip or mark the material. The method then ends at step 540.

Based on the foregoing, it can be appreciated that a number of embodiments, preferred and alternative, are disclosed herein. For example, in an embodiment, a non-marking impact resistant nut comprises a substantially cone shaped body, a central tubular channel formed in the cone shaped body, female threading formed in the central tubular channel, and at least two mounting holes formed in the cone shaped body.

In an embodiment, the body comprises a single seamless piece. In an embodiment, the cone shaped body is milled. In an embodiment, the body further comprises acetol.

In an embodiment the non-marking impact resistant nut further comprises an excised outer portion of the cone shaped body and a substantially flat inner surface.

In an embodiment the non-marking impact resistant nut further comprises a substantially flat base that is circular. In an embodiment the non-marking impact resistant nut further comprises a chamfer in the flat base around the opening of the central tubular channel.

In an embodiment the at least two mounting holes are configured linearly with the central tubular channel.

In an embodiment, the non-marking impact resistant is configured to fit flush against a grinder associated with a cutting tool. In an embodiment, the non-marking impact resistant nut is configured to fit flush against a blade associated with a cutting tool.

In another embodiment, a flange comprises a body tapered from a base of the body to the top of the body, a central tubular channel formed in the body, female threading formed in the central tubular channel, and at least two mounting holes formed in the cone shaped body.

In an embodiment, the base of the body comprises a substantially flat base. In an embodiment the flange further comprises a chamfer in the flat base around the opening of the central tubular channel. In an embodiment the flange further comprises a lip formed at an opening of the central tubular channel proximate to the base.

In an embodiment the body further comprises acetol. In an embodiment, the flange is configured to fit flush against a grinder associated with a cutting tool. In an embodiment the flange body comprises a single seamless piece.

In an embodiment the at least two mounting holes are configured linearly with the central tubular channel. In an embodiment, a diameter of the base of the body is larger than a diameter of the top of the body.

In another embodiment, a non-marking impact resistant nut comprises a substantially cone shaped body comprising a single seamless piece, wherein a diameter of a base of the body is larger than a diameter of a top of the body, a central tubular channel formed in the cone shaped body, female threading formed in the central tubular channel, at least two mounting holes formed in the cone shaped body, wherein the non-marking impact resistant nut is configured to fit flush against a grinder associated with a cutting tool.

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A non-marking impact resistant nut comprising:
a substantially cone shaped body;
a central tubular channel formed in the cone shaped body;
female threading formed in the central tubular channel; and
at least two mounting holes formed in the cone shaped body.

2. The non-marking impact resistant nut of claim 1 wherein the body comprises:
a single seamless piece.

3. The non-marking impact resistant nut of claim 2 wherein the cone shaped body is milled.

4. The non-marking impact resistant nut of claim 1 further comprising:
a substantially flat base.

5. The non-marking impact resistant nut of claim 4 wherein the substantially flat base is circular.

6. The non-marking impact resistant nut of claim 4 further comprising:
a chamfer in the flat base around the opening of the central tubular channel.

7. The non-marking impact resistant nut of claim 1 wherein the body further comprises acetol.

8. The non-marking impact resistant nut of claim 1 wherein the at least two mounting holes are configured linearly with the central tubular channel.

9. The non-marking impact resistant nut of claim 1 wherein the non-marking impact resistant nut is configured to fit flush against a grinder associated with a cutting tool.

10. The non-marking impact resistant nut of claim 1 wherein the non-marking impact resistant nut is configured to fit flush against a blade associated with a cutting tool.

11. A flange comprising:
a body tapered from a base of the body to the top of the body;
a central tubular channel formed in the body;
female threading formed in the central tubular channel; and
at least two mounting holes formed in the cone shaped body.

12. The flange of claim 11 wherein the base of the body comprises
a substantially flat base.

13. The flange of claim 12 further comprising:
a chamfer in the flat base around the opening of the central tubular channel.

14. The flange of claim 12 further comprising:
a lip formed at an opening of the central tubular channel proximate to the base.

15. The flange of claim 11 wherein the body further comprises acetol.

16. The flange of claim 11 wherein the at least two mounting holes are configured linearly with the central tubular channel.

17. The flange of claim 11 wherein the flange is configured to fit flush against a grinder associated with a cutting tool.

18. The flange of claim 11 wherein the body comprises:
a single seamless piece.

19. The flange of claim 11 wherein a diameter of the base of the body is larger than a diameter of the top of the body.

20. A non-marking impact resistant nut comprising:
a substantially cone shaped body comprising a single seamless piece, wherein a diameter of a base of the body is larger than a diameter of a top of the body;
a central tubular channel formed in the cone shaped body;
female threading formed in the central tubular channel;
at least two mounting holes formed in the cone shaped body, wherein the non-marking impact resistant nut is configured to fit flush against a grinder associated with a cutting tool.
